(19) United States
(12) Patent Application Publication
(10) Pub. No.: US 2007/0221760 A1
(43) Pub. Date: Sep. 27, 2007

(54) SPRAY HEAD WITH SIMPLIFIED ACTIVATION PARTICULARLY FOR KITCHEN SINKS

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 11/689,097

(22) Filed: Mar. 21, 2007

(30) Foreign Application Priority Data
Mar. 21, 2006 (IT) MI2006A000511

(51) Int. Cl. B05B 1/30; B05B 15/08

(52) U.S. Cl. 239/569; 239/587.1; 239/587.6

(57) ABSTRACT

Spray head with simplified activation particularly for kitchen sinks, comprising a body which can be connected to a water inlet duct and defining an inner chamber wherein a diverting valve element acts controlling two distinct water supply areas wherein the diverting valve element is axially mounted sliding and interacts with at least one cam slot defined by at least one oscillating equalizer which can be engaged by a slider supported by an oscillating button accessible on the external surface of the body.

### FIELD OF APPLICATION

The present invention relates to a spray head with simplified activation, particularly for kitchen sinks.

### PRIOR ART

As it is known, several types of kitchen sink spray heads are already on sale and commonly called “pulldown” spray heads, which are generally constituted by a body of mainly elongated configuration, and which offer the possibility to obtain two different types of jets for the water supply.

In prior art solutions, the passage from a supply type to another, and vice versa, is, generally, difficult to be activated and not immediately realizable by the user.

Moreover, another drawback frequently met is that these spray heads are structurally very complex and, consequently, they can be subject to damaging.

An aim of the present invention is that of eliminating the previously complained of drawbacks, realizing a spray head with simplified activation, particularly for kitchen sinks, which gives the possibility to allow the easy activation, by simply acting on a button.

Another aim of the invention is that of realizing a spray head which allows an immediate passage from a supply type to another and, moreover, which is structured so as to show a limited number of component elements.

A further aim of the present invention is that of realizing a spray head that, for its peculiar realization characteristics, is able to give the widest guarantees of reliability and safety of use.

Another aim of the present invention is that of realizing a spray head which can be easily obtained starting from elements and materials being commonly available on sale and which, moreover, is competitive from a merely economic point of view.

### SUMMARY OF THE INVENTION

According to the present invention, the above described aim is obtained by a sink spray head with simplified activation particularly for kitchen sinks, according to the invention, comprising a body which can be connected to a water inlet duct and defining an inner chamber wherein a diverting valve element acts to control two distinct water supply areas, characterized in that the diverting valve element is slidably, axially mounted and interacts with at least one cam slot defined by at least an oscillating equalizer that can be engaged by a slider supported by an oscillating button accessible on the external surface of said body.

Further characteristics and advantages will be better apparent from the description of a preferred, but non exclusive, embodiment of a spray head with simplified activation particularly for kitchen sinks, shown by way of indicative and non limiting example with the help of the annexed drawings.

### BRIEF DESCRIPTION OF THE DRAWINGS

FIG. 1 schematically shows a perspective view of the spray head with simplified activation according to the invention;

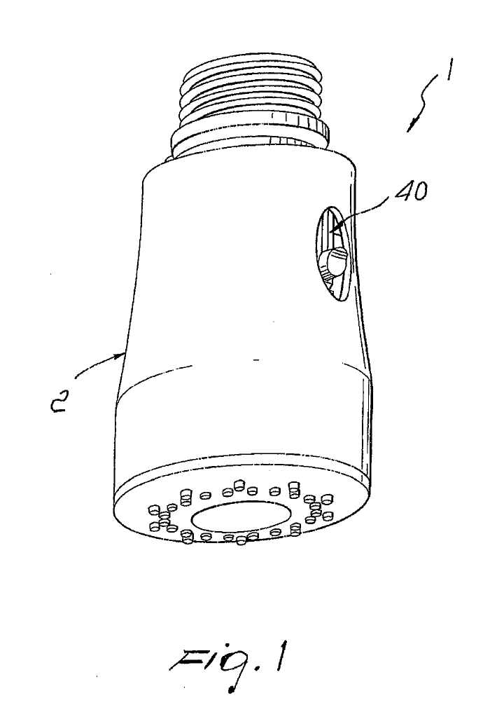

FIG. 2 shows a perspective view of a partial cross-section of the spray head;

FIG. 3 shows a section view of the spray head along an axial plane, the valve element being in a first position;

FIG. 4 shows a section view of the spray head along an axial plane, the valve element being in a second position.

### DETAILED DESCRIPTION OF A PREFERRED EMBODIMENT

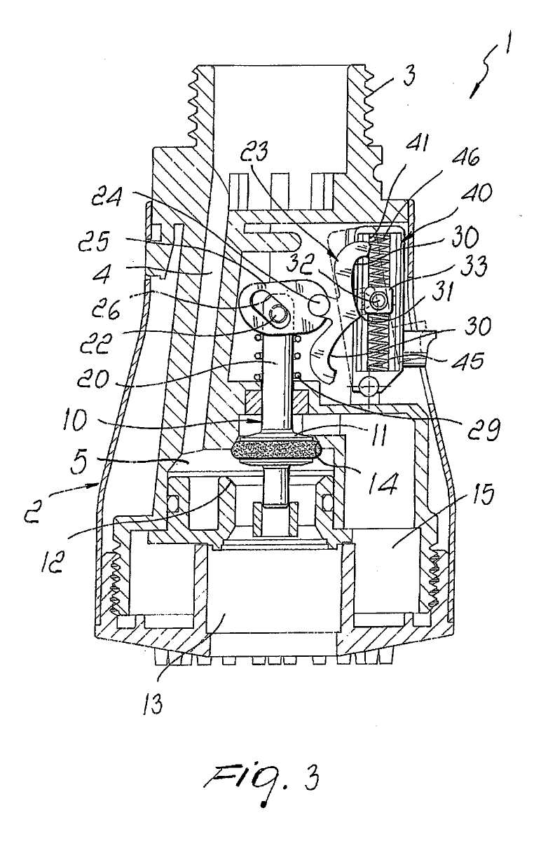

With reference to the cited figures, the spray head with simplified activation particularly for kitchen sinks and the like, which is globally indicated with reference number 1, comprises a body 2 which defines, on top, and a mouth 3 (FIG. 3) for the connection to a water inlet duct.

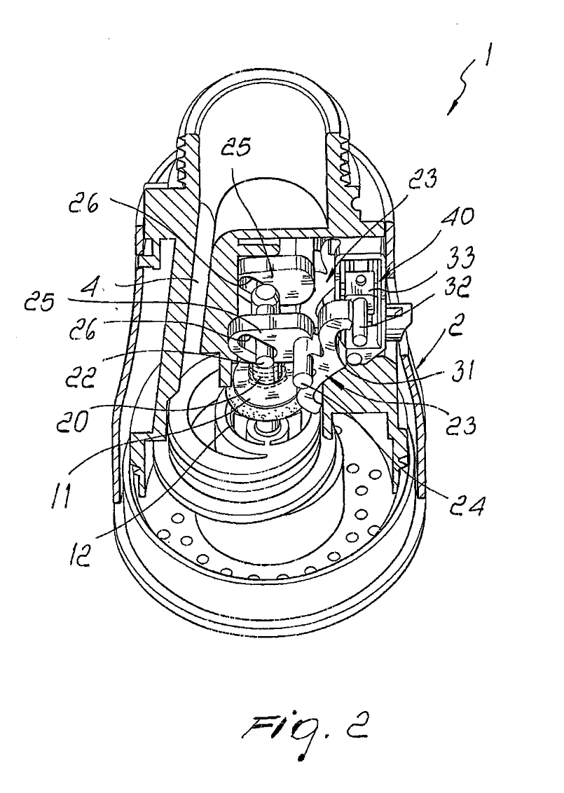

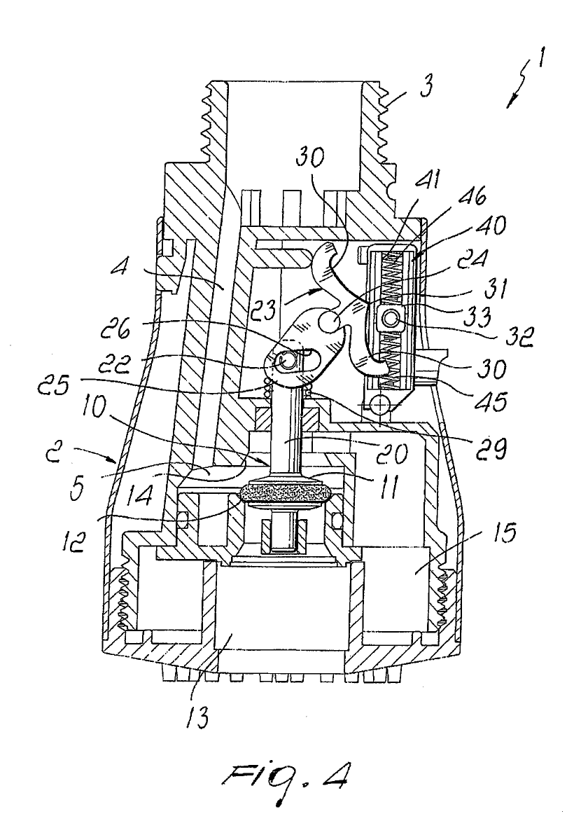

As shown in FIGS. 2-4, the mouth 3 is connected, by means of a connection duct 4 to an inner chamber 5 wherein a diverting valve element, globally indicated with reference number 10, acts, which comprises a cut-off 11 equipped with gasket or which controls a first seat 12 in communication with a central supply area 13 and a second seat 14 in communication with a peripheral supply area, indicated with 15.

A peculiarity of the invention is that the cut-off 11 is mounted on a small shaft 20 which is axially sliding.

The small shaft 20, at its free end, shows a transversal pivot 22 which engages with two oscillating equalisers both indicated with 23 which are symmetrically arranged beside the small shaft 20.

The oscillating equalizers 23 show a fulcrum 24 connected to the structure of the body and have an activation plate 25 which defines an inclined slot 26 wherein the transversal pivot 22 engages, so as to transform the rectilinear movement for the small shaft 20 into an oscillation movement around the fulcrum 24 of the equalizer 23.

A spring 29 is then provided acting between the transversal pivot 22 and the structure of the spray head which has the function of bringing the cut-off 11 back to close the second seat 14, when the water supply is interrupted.

The equalizer 23, on the opposite side with respect to the activation plate 25, shows a pair of grooves 30 divided by a central cusp 31.

In the grooves 30 a transversal pin 32 is engaged by contact which is connected to a slider 33 which is slidingly housed in a button 40 which is mounted sliding and is accessible outside the body.

The button 40, which is positioned below a gum covering element placed on the external surface of the body 2, defines a sliding guide 41 wherein the slider engages whereon equalising springs 45 and 46 act having the function of bringing always the slider 33 and consequently the pin 32 into a central position when the activation has ended.

In the practical operation and by exerting a pressure action on the button 40, the oscillation of the button itself is caused and the pin 32 engages in the grooves 30 of the equalizer 23 obtaining, consequently, the oscillation of the equalizer and the consequent translation of the small shaft 20.

The presence of the central cusp 31 makes the pin 32, when activated, always cause the oscillation of the equalizer since the cusp is arranged on one side or on the other of the pin and, consequently, the pin, when engaged with the groove 30, causes the rotation, in a sense or the other sense, of the equalizer 23 and consequently the translation in a sense or the opposite one of the small shaft 20, with change of the supply type for the spray head.

With the above described arrangement, a particularly simple structure is obtained which is based on the transformation of the oscillating motion of the button by means of the equalizer which converts its oscillation into a translation for the small shaft which leads the cut-off to engage with the first or the second seat.

As per what has been shown above, it is clear how the invention attains the proposed aims and, in particular, the extreme realisation simplicity of the spray head, which can be obtained with a limited number of component elements, is underlined.

The invention thus conceived can be subjected to several modifications and versions all within the inventive concept.

Moreover, all the details will have the possibility to be substituted by other technically equivalent elements.

In practice, the materials used, as well as the dimensions and the specific shapes, will be of any type according to the needs.

Advantageously, the spray head according to the present invention allows an immediate passage from a supply type to another and, moreover, it is structured so as to show a limited number of component elements.

Moreover, the spray head, for its peculiar realization features, is able to give the widest guarantees of reliability and safety of use.

Least but not last the spray head may be easily obtained starting from elements and materials being commonly available on sale and which, moreover, is competitive from a merely economic point of view.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A spray head with simplified activation particularly for kitchen sinks, comprising a body which can be connected to a water inlet duct and defining an inner chamber wherein a diverting valve element can be actuated to control two distinct water supply areas, wherein the diverting valve element is axially, slidingly mounted and interacts with at least one cam slot defined by at least one oscillating equalizer which can be engaged by a slider supported by a button accessible on the external surface of the body.

2. The spray head of claim 1, wherein the diverting valve element comprises a shaft supporting a cut-off (equipped with a gasket or controlling a first seat in communication with a central supply area and a second seat in communication with a peripheral supply area.

3. The spray head of claim 2, wherein the spray head comprises, at the free end of the shaft, a transversal pivot engaging with the at least one oscillating equalizer, mounted oscillating and symmetrically positioned beside the small shaft.

4. The spray head of claim 1, wherein the at least one oscillating equalizer comprises a fulcrum of connection to the structure of the body and defines an activation plate where an inclined slot is positioned defining the cam slot.

5. The spray head of claim 4, comprising, on each of the at least one oscillating equaliser, on the opposite side with respect to the activation plate, a pair of grooves separated from each other by a central cusp, with the grooves engaging by contact a transversal pin connected to the slider.

6. The spray head of claim 1, wherein the slider is slidingly housed in the button.

7. The spray head of claim 1, comprising an equalizing spring acting on the slider for the positioning of the slider in the absence of activation.
